(19) United States
(12) Patent Application Publication
(10) Pub. No.: US 2017/0024713 A1
(43) Pub. Date: Jan. 26, 2017

(54) WEARABLE DEVICES AND SYSTEMS FOR EVENT ADMINISTRATION AND EVENT RELATED TRANSACTIONS

(71) Applicant: PAYPAL, INC., San Jose, CA (US)

(72) Inventors: Ryan May, San Jose, CA (US); Darren Joseph Smith, San Jose, CA (US); Con Vafeas, San Jose, CA (US); Max Edward Metral, Brookline, MA (US); Satish Narayan Govindarajan, Los Altos, CA (US); Anantharaj Uruthiralingam, San Jose, CA (US)

(21) Appl. No.: 15/217,932

(22) Filed: Jul. 22, 2016

Related U.S. Application Data
(63) Continuation of application No. 62/196,284, filed on Jul. 23, 2015.

(51) Int. Cl. G06Q 20/10; G06Q 20/32

(52) U.S. Cl. CPC G06Q 20/102; G06Q 20/3278

(57) ABSTRACT

Wearable devices, such as wrist bands, mobile devices, cards, name tags, or the like, are provided for facilitating various transactions at events. Further, a system is provided that allows an event organizer to manage transactions among various entities in an event via the wearable devices. In particular, a wearable device with unique identification may be given to each attendee. The attendee may use the wearable device to gain access to various parts of the event and make purchases at various vendors or merchants. The system may manage transactions made by the attendees using the wearable devices.

### CROSS REFERENCE TO RELATED APPLICATION

Pursuant to 35 U.S.C. §119(e), this application claims priority and the benefit of U.S. Provisional Patent Application Ser. No. 62/196,284, filed Jul. 23, 2015, which is incorporated by reference in its entirety.

### BACKGROUND

Field of the Invention

The present invention generally relates to wearable devices and systems for event administration and event related transactions.

Related Art

Public events such as, live performances, sports, games, music concerts, festivals, conferences, and the like, typically involve interactions and transactions among a plurality of entities, such as the event organizer, the event attendees, merchants, vendors, sponsors, advertisers, and the like. For large public events that involve a large number of different entities, attendees, vendors, merchants, and the like, it may become challenging for an event organizer to implement various administration and transactions that take place in the event. Thus, there is a need for a system or method that enables an event organizer to better manage various event related administration and transactions.

### BRIEF DESCRIPTION OF THE FIGURES

FIG. 1 is a block diagram of a networked system suitable for implementing wearable devices for event related administration and transactions according to an embodiment.

FIG. 2 is a block diagram of a wearable device suitable for implementing event related transactions according to one embodiment.

FIG. 3 a diagram illustrating a system for using a wearable device for event related transactions according to one embodiment.

FIG. 4 is a diagram illustrating an overall process flow for using a wearable device for event related transactions according to one embodiment.

FIG. 5 is a diagram illustrating a customer activation process according to one embodiment.

FIG. 6 is a diagram illustrating a wearable device registration process according to one embodiment.

FIG. 7 is a diagram illustrating a transaction process using a wearable device according to one embodiment.

FIG. 8 is a diagram illustrating a transaction flow in an organizer run event according to one embodiment.

FIG. 9 is a diagram illustrating a transaction flow in an open market place event according to one embodiment.

FIG. 10 is a diagram illustrating a transaction flow in a marketplace closed loop event according to one embodiment.

FIG. 11 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Public events, such as conferences, sport games, concerts, festivals, trade shows, and the like, may have hundreds or thousands of attendees and may involve various entities, such as vendors, merchants, advertisers, service providers, and the like. Thus, it may be challenging for event organizers to manage various interactions and transactions among the attendees and various entities, such as payment transactions, event admittance, and the like.

There may be at least three different event payment models: 1. organizer only model; 2. open marketplace model; and 3. closed loop marketplace model. Some events may utilize a combination of two or more of these three payment models. In the organizer only model, the event organizer manages and operates all goods or services sold in the event. The staff of the event organizer may work at all locations of the event and the event organizer is the merchant of record in the payment transactions. However, the event organizer may need to set up point of sale equipment even for events that occur only a few days of a year. The organizer only payment model often is used in public events, such as music festivals.

In the open marketplace payment model, the event organizer may charge fixed cost to vendors or merchants for space at the event. The vendors or merchants may service and charge customers or event attendees for goods. Thus, the vendors or merchants are the merchant of record in payment transactions. Event organizer also may charge a transactional fee for each purchase made. The open marketplace payment model is often used in conferences or craft/sport shows.

In the closed loop marketplace payment model, the event organizer may set up an event currency, such as coupons or tokens. The vendors or merchants may provide goods or service to attendees or customers. The event organizer is the merchant of record in the payment transaction. The event organizer then pays the vendors based on the coupons/tokens earned by the vendors or merchants. The closed loop marketplace payment method is often used in food or drink events.

There are a number of challenges in managing or implementing transactions in live events. For event organizers, there are no consistent payment methods that are acceptable across all merchants or vendors. Thus, the event organizer needs to spend time and effort in reconciling payment transactions with various vendors or merchants. Further, no data is collected on the transactions that occurred at the event, such as who bought what from where.

For the vendors or merchants, setting up point-of-sale at the event location may be complicated. Vendors or merchants also have to wait for three to thirty days after the event to receive payment from the organizer. There is a need for the vendors or merchants to have a seamless payment process for customers or event attendees.

For the customers or attendees, there may be a long wait in line for tickets to the event. If a merchant or vendor does not accept certain method of payment, the customer or attendee would have to find an ATM to obtain cash for payment. Further, for events that require event currency, such as tokens or coupons, the attendee or customer would have to line up to buy the event currency. In general, it is inconvenient for customers or attendees to carry a large amount of cash at the event. Some customers or attendees also prefer not to carry phones or wallet at certain public events, such as at a music festival.

According to an embodiment of the invention, a system is provided that allows an event organizer to manage transactions among various entities in an event via wearable devices, such as wrist bands, a mobile devices, cards, name tags, or the like. In particular, a wearable device with unique identification may be given to each attendee. The attendee may use the wearable device to gain access to various parts of the event and make purchases at various vendors or merchants. The system may manage transactions made by the attendees using the wearable devices.

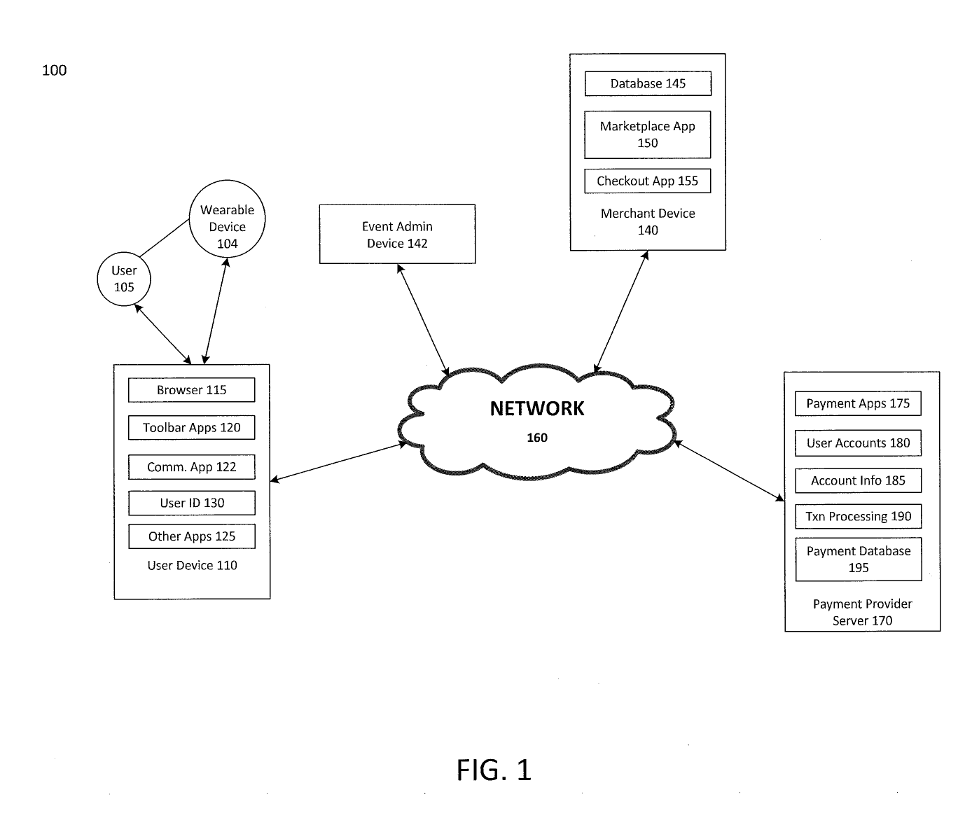

FIG. 1 is a block diagram of a networked system suitable for implementing wearable devices for event related administration and transactions according to an embodiment. FIG. 1 is a block diagram of a networked system suitable for implementing wearable devices for user authentication according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant device 140, an event administrator's device 142, and a payment provider server 170 in communication over a network 160. A wearable device 104 may be worn by user 105. The user 105 may use the wearable device 104 to gain access to the event and to make payment transactions at various vendors and/or merchants at the event. Payment provider server 170 may be maintained by a payment service provider, such as PayPal, Inc. of San Jose, Calif. A user 105, such as an event attendee or a consumer, utilizes wearable device 104 to perform a transaction. User 105 may utilize wearable device 104 to initiate a payment transaction, receive a transaction approval request, or reply to the request. Note that transaction, as used herein, refers to any suitable action, including payments, transfer of information, display of information, etc. Although only one merchant device is shown, a plurality of merchant devices may be utilized by different merchants or vendors at the event.

In some embodiments, the user 105 may have a payment account at the payment provider server 170. The payment account may allow user 105 to purchase and/or pay for various products or services at a merchant. The wearable device 104 may be associated with the payment account of the user 105 and be used for user authentication and/or payment transaction. The wearable device 104 may communicate and/or interact with the merchant's device 140 at the point-of-sale to initiate and process payment transactions.

User device 110, merchant device 140, event administrator's device 142, payment provider server 170, and wearable device 104 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, user device 110 may be implemented as a personal computer (PC), a smart phone, laptop computer, a wearable computing device, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for setting up a shopping list and/or merchant sites for viewing and purchasing products and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 may further include other applications 125 as may be desired in particular embodiments to provide desired features to user device 110. For example, other applications 125 may include security applications for implementing client-side security features, programmatic client applications for interfacing with appropriate application programming interfaces (APIs) over network 160, or other types of applications.

Applications 125 may also include email, texting, voice and IM applications that allow user 105 to send and receive emails, calls, and texts through network 160, as well as applications that enable the user to communicate and transfer information. User device 110 includes one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

Merchant device 140 may be maintained, for example, by a merchant or seller offering various products and/or services. The merchant may have a physical point-of-sale (POS) store front. The merchant may be a participating merchant who has a merchant account with the payment service provider. Merchant device 140 may be used for POS or online purchases and transactions. In some embodiments, the merchant device 140 may be a mobile communication device that includes a merchant app downloaded from the payment service provider for facilitating payment/purchases. Generally, merchant device 140 may be maintained by anyone or any entity that receives money, which includes service providers as well as banks and retailers. Merchant device 140 may include a database 145 identifying available products (including digital goods) and/or services (e.g., collectively referred to as items) which may be made available for viewing and purchase by user 105. Accordingly, merchant device 140 also may include a marketplace application 150 which may be configured to serve information over network 160 to browser 115 of user device 110. In one embodiment, user 105 may interact with marketplace application 150 through browser applications over network 160 in order to view various products, food items, or services identified in database 145.

Merchant device 140 also may include a checkout application 155 which may be configured to facilitate the purchase by user 105 of goods or services online or at a physical POS or store front. Checkout application 155 may be configured to accept payment information from or on behalf of user 105 through payment service provider server 170 over network 160. For example, checkout application 155 may receive and process a payment confirmation from payment service provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Merchant device 140 also may include a short range wireless communication interface configured to communicate with wireless devices located near the merchant device 140. The short range wireless communication interface may allow the merchant device 140 to communicate and interact with devices in short range wireless communication, such as RFID, Bluetooth, Near-Field Communication (NFC), or the like. For example, the wearable device 104 may interact with merchant device 140 via RFID, NFC, or Bluetooth to initiate or process payment transactions. The event attendee may tap the wearable device 104 on the merchant device 140 to make payment to the merchant.

Payment provider server 170 may be maintained, for example, by an online payment service provider which may provide payment between user 105 and the operator of merchant device 140 and manage payment transactions among the event administrator, the merchants, and the attendees. In this regard, payment provider server 170 includes one or more payment applications 175 which may be configured to interact with user device 110, event administrator' device 142, and/or merchant device 140 over network 160 to facilitate the purchase of goods or services, communicate/display information, and send payments.

Payment provider server 170 also maintains a plurality of user accounts 180, each of which may include account information 185 associated with consumers, merchants, event organizers, and funding sources, such as banks or credit card companies. For example, account information 185 may include private financial information of users of devices such as account numbers, passwords, device identifiers, user names, phone numbers, credit card information, bank information, or other financial information which may be used to facilitate online transactions by user 105. In an embodiment, the account information 185 also may include information about wearable devices of the user 105 that are associated with the user account of the user 105 and that may be used to provide user authentication for accessing the user account. Advantageously, payment application 175 may be configured to interact with merchant device 140 on behalf of user 105 during a transaction with checkout application 155 to track and manage purchases made by users and which and when funding sources are used.

A transaction processing application 190, which may be part of payment application 175 or separate, may be configured to receive information from user device 110 and/or merchant device 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

Even administrator's device 142 may be implemented by an event administrator or event organizer to set up, manage, and implement transactions among attendees, vendors, and merchants at an event. The event administrator's device 142 may have one or more similar components as that of the user device 110. In particular, the event administrator's device 142 may check in attendees at the beginning of an event, assigning wearable devices to attendees, manage and monitor transactions at the event, and the like. The event administrator's device 142 may be connected to the payment provider server 170 to access various event related applications to manage event related transactions.

Wearable device 104 may be worn by an event attendee. The wearable device 104 may serve to authenticate the event attendee. The wearable device may include a sensor, such as an optical sensor or a pressure sensor, configured to detect whether the wearable device is worn by or is with the user. When the sensor detects that the wearable device is taken off or otherwise separated from the user, the wearable device 104 may need to be authenticated again. This may prevent unauthorized use of the wearable device 104.

For example, the sensor of the wearable device 104 may be provided at an inner surface of the wearable device facing the user when the wearable device is worn by the user. The sensor may be an optical sensor configured to detect ambient light level. When the wearable device is worn by the user, the optical sensor may be covered by a body part of the user and may not receive light. When the wearable device is taken off from the user, the optical sensor may be exposed and may receive light. As such, the optical sensor may detect whether the wearable device is worn by the user.

In an embodiment, the sensor of the wearable device may be an actuator, such as a button, which may be depressed when the wearable device is worn by the user and may be released when the wearable device is taken off the user. In another embodiment, the sensor may be a temperature sensor configured to detect a temperature. For example, the temperature sensor may detect a body temperature of the user when the wearable device is worn by the user and may detect ambient temperature of the user when the wearable device is taken off from the user. In still another embodiment, the sensor may be a proximity sensor configured to detect a presence of the user when the wearable device is worn by the user. In yet another embodiment, the sensor may be a pressure sensor or touch sensor configured to detect a pressure force or a touch from the user when the wearable device is worn by the user. Other sensors, such as a gyroscope, accelerometer, and the like, also may be used to detect an orientation and movement of the wearable device to determine whether the wearable device is worn by the user or has been taken off from the user.

In an embodiment, the wearable device may be a wrist band type device configured to provide be worn on the user's wrist. In another embodiment, the wearable device may be a jewelry type item, such as a ring, a necklace, a wrist band, and the like. In still another embodiment, the wearable device may be a belt, a neck tie, a tie pin, a collar stay, and any other wearable accessories. In still another embodiment, the wearable may be a clip or a tab configured to be attached to the user or other items carried by the user.

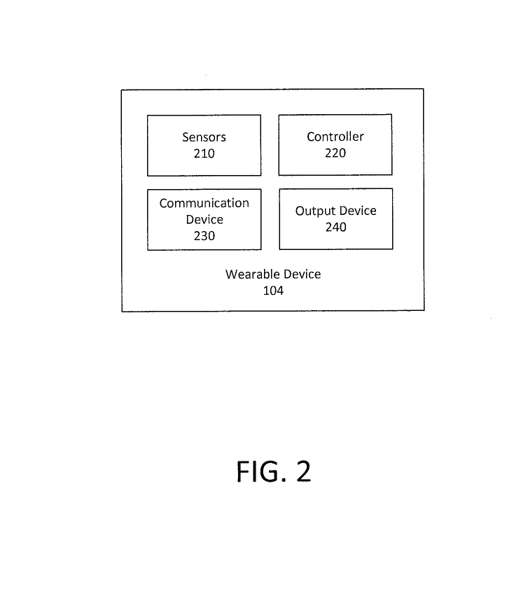

FIG. 2 is a block diagram of a wearable device suitable for implementing event related transactions according to one embodiment. Wearable device 104 may be a wearable item that may be worn by the user 105 or be attached to the user 105 or other items carried by the user 105. As such, the wearable device 104 may be a personal item to the user 105 that is worn or carried by the user 105. The wearable device 105 may include a sensor 210 configured to detect whether the wearable device 105 is currently being worn by the user 105.

In some embodiments, the wearable device 104 may include biometric sensors, such as a fingerprint reader to authenticate the user. For example, when the wearable device 104 is not registered or inactive, the user may authenticate himself/herself by the fingerprint reader to activate or register the wristband with the user's payment account. This may provide additional security to prevent unauthorized use of the wearable device 104. In some embodiments, the user may be required to authenticate himself/herself via the biometric sensor on the wearable device 104 before using the wearable device 104 for payment or other transactions. For example, the wearable device 104 may remain inactivated most of the time and may be activated by the user scanning his/her finger on the fingerprint reader of the wearable device 104 before the user use the wearable device 104 to make a payment or other transactions. Various types of biometric sensors may be used, including fingerprint sensor, heartbeat sensor, body temperature sensor, skin conductance sensor, and any combination thereof.

The wearable device 104 may include a communication device 230 configured to communicate with other devices. The communication device 230 may include a short range communication device, such as RFID, a Bluetooth or Bluetooth Low Energy (BLE) communication device, a Near-Field Communication (NFC) device, WiFi, or a combination thereof. The signal range of the communication device 230 may be limited to a few feet, such that nearby devices may detect and/or communicate wirelessly.

The wearable device 104 may include a controller 220 configured to manage and control various operations of the wearable device 104. The controller 220 may include a microprocessor, an integrated circuit, or a combination thereof. The wearable device 104 also may include an output device 240 configured to communicate with user 105. For example, output device 240 may be an audio signal emitter configured to emit audio signals to the user 105. In another example, output device 240 may be an LED component configured to provide visual output. In still another example, output device 240 may be a vibration device configured to vibrate to communicate with user 105. In some embodiments, output device 240 may include one or more types of different output devices, such as a combination of an LED component and an audio signal emitter to provide different types of outputs to the user 105.

The wearable device 104 may be powered by a battery, which may be a rechargeable battery. For example, the wearable device 104 may be powered by solar battery or by kinetic energy, such as the movement of user 105. In another example, the wearable device 104 may be powered by replaceable batteries. Other types of wearable devices 104 that may be attached to or carried by the user 105 also may be utilized. For example, the wearable device 104 may be a clip configured to attach to the user 105 or items carried by the user 105. In another example, the wearable device 104 may be a tab that may be inserted or placed inside a bag or a wallet of the user 105.

Use restrictions may be designated for the wearable device 104 based on the event administration and user account. For example, an event attendee may be registered to attend only a certain portion of the event. As such, the wearable device 104 may allow the event attendee to access only the registered portions of the event. In another example, the wearable device 104 may be activated for only a certain date, time, and location, such as the date, time, and place of the event. As such, the wearable device 104 may be deactivated outside the designated location or outside of the designated date and time. This may provide additional security to the wearable device 104 to prevent unauthorized use of the wearable device 104 outside of the event.

In some embodiments, the wearable device 104 may be restricted for use with certain type of merchants or vendors. For example, the wearable device 104 of an underage attendee may be prohibited from making purchase from an alcoholic beverage vendor. Other restrictions, such as VIP area, age, access level, parking area, and the like, also may be designated to manage or control access by different types of attendees.

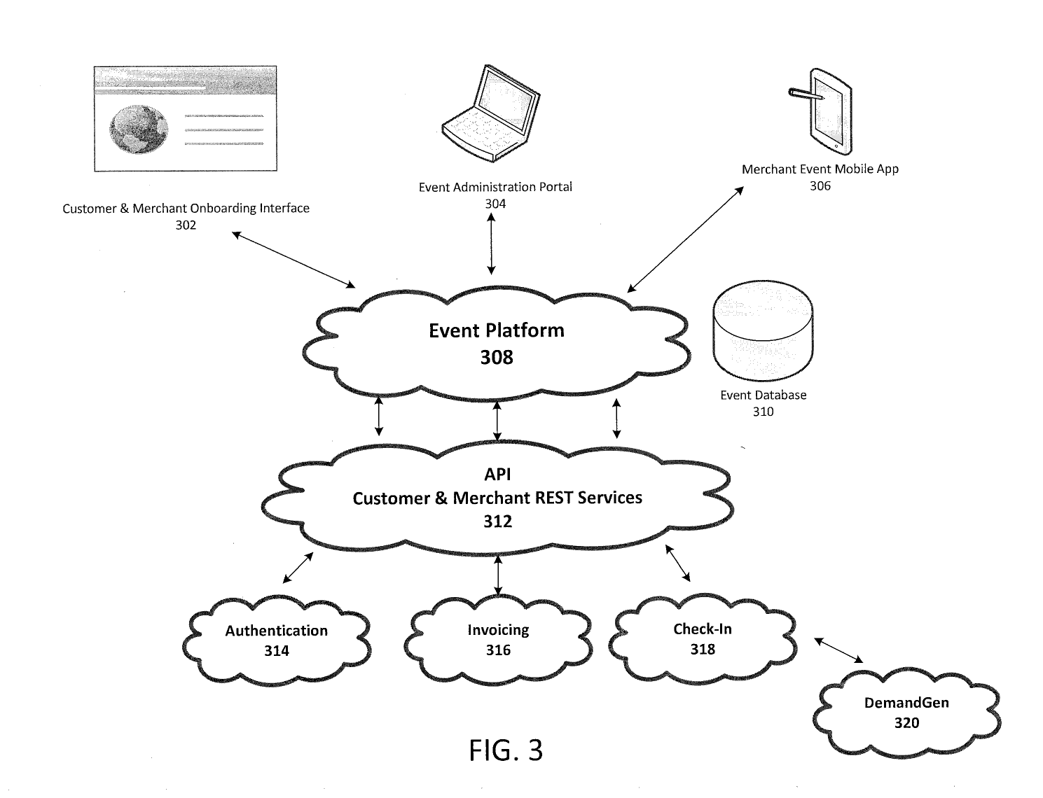

FIG. 3 a diagram illustrating a system for using a wearable device for event related transactions according to one embodiment. As shown in FIG. 3, the payment provider server 170 may implement a system that provides various services to the event organizer, the event attendees, and the event merchants/vendors. In particular, the system may provide customer and merchant onboarding interface 302 to merchants and event attendees to sign up/set up their attendance to the event. The customer and merchant onboarding interface 302 may allow event attendees and merchants to register by providing their personal/business information online before they attend the event. The system also may provide an event administration portal 304 for the event organizer to manage event transactions. The event administration portal 304 may provide an user interface for the event organizer to check in and assign wearable devices to attendees at the beginning of the event. Further, the system may provide a merchant event mobile app 306 for merchant mobile devices to facilitate purchases/payments made via the wearable device 104. For example, the merchant event mobile app 306 may coordinate with a wearable device reader to authenticate a customer and allow for payment and purchase made via the wearable device.

The system also may include solution specific services, such as event API services and storage, such as an event platform 308 and database 310 for managing and storing information related to the admin users, events, customers, vendors, and wearable devices (wristbands). The system also may include externally available partner services and may be supported in different countries. The system may provide various functions including authentication (via wearable devices) 314, invoicing 316, check-in 318, DemandGen 320, and the like.

The customer and merchant onboarding interface 302 may allow event attendees and/or merchants to register for the event before the event. For event attendees, the system may provide an email or a website that allows the event attendees to login (via their payment account) to register for the event. The system may offer incentives, such as credits or coupons, that may be used for the event to incentivize the event attendees to register for the event through their payment accounts. Thus, the event attendee may register for the event by first logging into his/her payment account. Event attendees without a payment account may sign up for a new payment account. The system may ask the event attendee's permission to share their contact details, language, and accept privacy and user agreement. The system also asks the event attendee's permission to allow the system to check in the event attendee at merchants so that the event attendee may make payments with the payment service provider.

After the event attendee is logged in, the system may check that the event attendee's PayerID or email is included in the list of attendees for the event. The system may save, refresh, and access token, test for check-in capabilities, and check for photo upload. If the registration process is successful, the system may present the event attendee with a completion information, including a confirmation that the event attendee is now enrolled for making payments using an event wrist band, e.g., wearable device, that the event attendee may pick up the wrist band at the event, and that the event attendee may use the wrist band to make purchases at the event. If the registration process is not successful, the system may present information to the event attendee including reasons for the errors.

For merchants/vendors, the customer and merchant onboarding interface 302 may allow merchants to register for the event through their payment accounts. Thus, the merchants may register for the event by first logging into the merchant's payment account. Merchants without a payment account may sign up for a new payment account. The system may ask the merchant's permission to share their contact details, language, and accept privacy and user agreement. After the merchant is logged in, the system may save, refresh, and access token; check account status; and save merchant to event relationship. Thus, the merchant is registered for the event and ready to receive payments through a POS at the event from event attendees' wearable devices, e.g., wrist bands.

The system may provide event administration portal 304 for the event organizer/administrator to manage transactions at the event. The event organizer may user the event administration portal 304 to configure and setup events in the system prior to onboarding as well as on the day of the event for registration of the event attendees and pick up of the wrist band (wearable devices). The event administration portal 304 may be presented on a web browser at the event administrator's device 142 and may be run as a Chrome App to allow USB communication with a wristband reader (wearable device reader) on the event day for wristband interaction.

The event administration portal 304 may include event creation that allows an event organizer to create and set up a new event. The event administration portal 304 also may include an event dashboard configured to provide live statistics on event day. The live statistics may include event attendee registration status, transactions and taps by 30-minute intervals, transactions and taps per hour, recent taps with user photo, merchant transaction rankings, transaction rankings by merchant type, and the like.

The event administration portal 304 also may include customer management that allows the event organizer to add or remove event attendees from the event, look up/search for event attendees and register wristbands. The event administration portal 304 also allows merchant/vendor management that allows the event organizer to add or remove merchants from the event, view and/or monitor specific merchant/vendor transactions. The event administration portal also implements wristband management (wearable device management). For example, the event organizer may use event administration portal 304 to look up, activate new wrist bands, or deactivate lost or stolen wrist bands.

The system may provide application at the merchant's device 140 to process payment transactions at the event. During a purchase transaction, the merchant may enter the total amount of purchase at the merchant's device 140. A wearable device reader may be included or connected to the merchant device 140 to read the wearable device of the event attendee who is making the purchase. The event attendee may tap the wearable device on the wearable device reader. The wearable device reader may read the wearable device when tapped and send the encrypted information stored in the wearable device to the payment provider server 170. The encrypted information may include unique card information such as track 1 and track 2 card information. The payment application may check the masked track data for specific fictional IIN number to determine whether the wristband is a valid wrist band. The payment application then may extract an unique identifier from the track 2 discretionary data, such as a wristband ID. The wristband ID is sent to the Events Platforms API at the payment provider server 170 to be authenticated against event attendees at the event along with location ID of the vendor.

After ensuring that the vendor is registered at the event and that the wristband is activated and registered to the event attendee, the system uses its previously granted customer permissions to check in the event attendee and return the TabID to the payment application at the merchant's device 140. The merchant's device 140 may present an on-file photo of the event attendee making the purchase. The merchant may confirm that the picture matches the event attendee using the wrist band and may confirm payment transaction.

The system architecture may be designed to use shared services for all admin, customer, and vendor event applications. The Event API service leverages publically available customer and merchant REST services 312 given to POS and wallet partners. Permissions are granted to Event Platform 308 through Log In with PayPal third party authorization. The system may be designed to accommodate all three types of event payment models with global re-usability in mind.

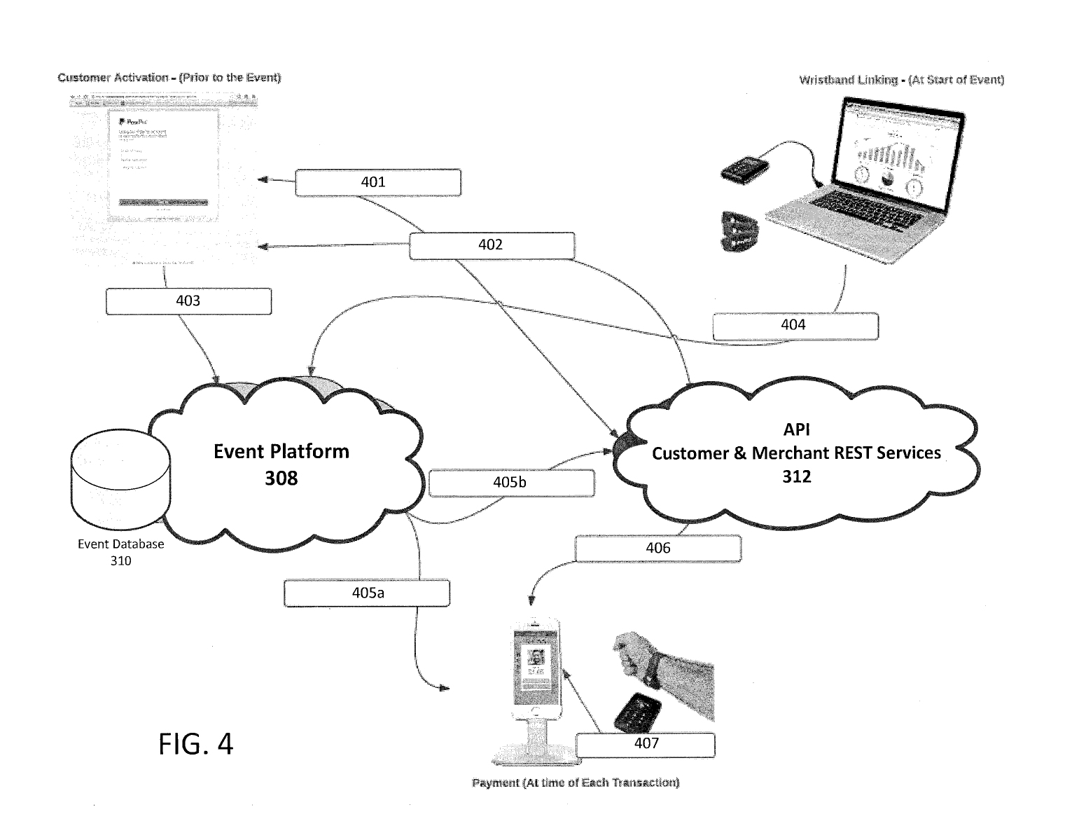

FIG. 4 is a diagram illustrating an overall process flow for using a wearable device for event related transactions according to one embodiment. The process flow may begin with step 401—Request Permissions, in which the system asks for the event attendee/merchant's permission to use their payment account to register for the event. At step 402, if the event attendee/merchant grants permission, the system may access and obtain account information from the payment account for use with the event. At step 403, the account information may be stored at the event database 310 with the Event Platform 308 to be used for event related transactions. At step 404, the event attendee arrives at the event and picks up a wrist band (wearable device) from the event organizer. The wrist band is associated with the event attendee. In particular, the system extracts and saves the unique wristband ID with the event attendee's profile at the Event Platform 308.

At step 405a, when an event attendee is making purchase at a merchant/vendor, the event attendee may tap the wrist band at the merchant's device to make payment. The merchant device 140 may read/extract the wristband ID from the wristband. At step 405b, when an event attendee is visiting a merchant/vendor, the event attendee is checked in with the merchant/vendor. This may be done by determining the location/movement of the event attendee at the merchant/vendor by detecting the presence of the wrist band worn by the event attendee. The wrist band may be detected wirelessly, such as by a wireless beacon installed at the merchant. After user authentication (by wristband ID and by event attendee's picture) at step 407, the system may initiate and process a payment transaction at steps 406.

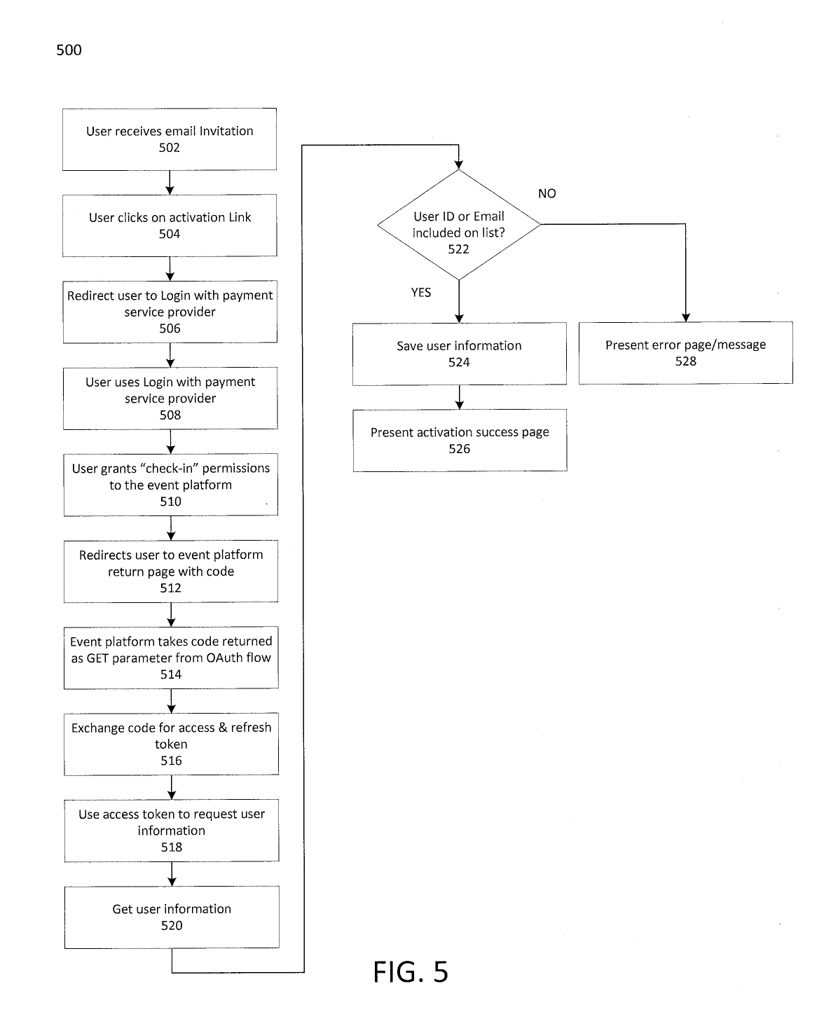

FIG. 5 is a diagram illustrating a customer activation process 500, such as at steps 401-403 in FIG. 4. The system may first send an event attendee an email invitation to participate in the wristband program. The user 105 may receive the email invitation at step 502. At the customer's device (user device 110), the user 105 may click on an activation link in the email invitation at step 504. The user 105 is then redirected to login with the payment service provider (PayPal) at step 506. After logging in with the payment service provider at step 508, the user 105 may grant “check-in” permissions to the event platform at step 510. The user then is redirected to the Event Platform Return Page with Code at step 512. Event Platform 308 may take the code as GET parameter from OAuth flow at step 514. The code is then used to exchange access and refresh token at step 516. The access token is used to request user information at step 518 and to get user information at step 520. Event Platform 308 then checks to see if PayerID or email is included in the list of event attendees at step 522. If not, the customer is presented with an error/page or message, such as a non-invite message at step 528. If so, the customer's PayerID, refresh token, email, first and last name are saved with the Event Platform database at step 524. The customer is then presented with registration success page at step 526.

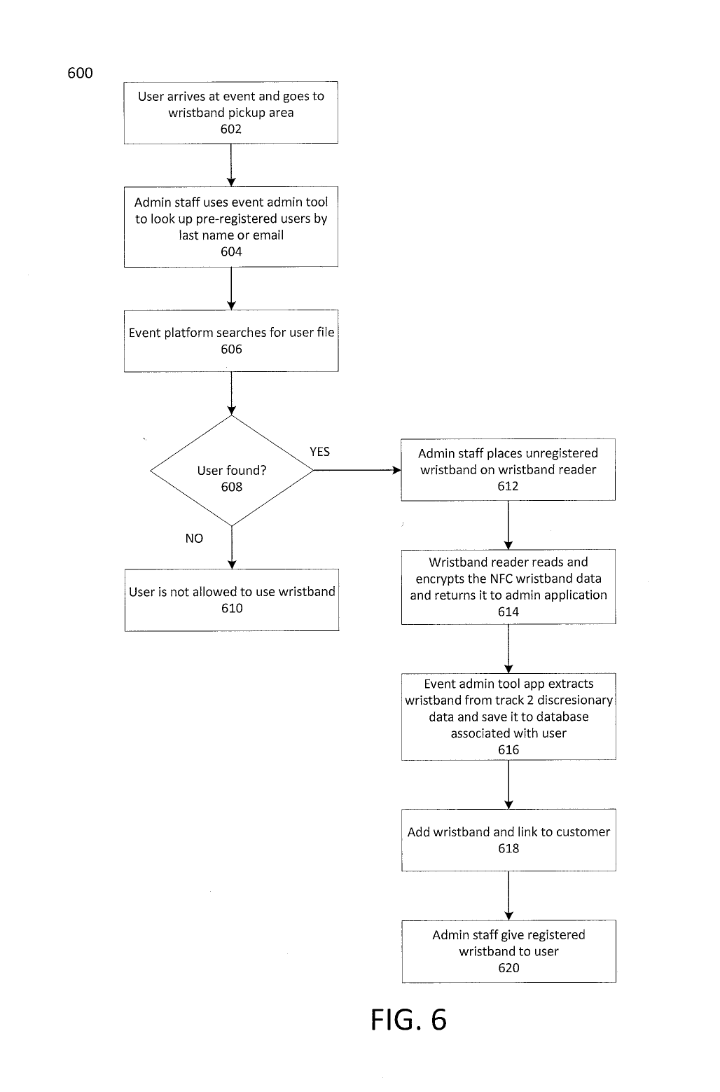

FIG. 6 is a diagram illustrating a wearable device registration process 600, such as at step 404 of FIG. 4. When a customer (event attendee) arrives at an event, the customer may go to an event wrist band pick up area at step 602. Event staff uses the Event admin tool to look up pre-registered customer by last name or email at step 604. The Event Platform 308 performs customer GET function to find the customer at step 606. If not found at step 608, the customer is not allowed to use wristband at step 610. If found, the event staff places an unregistered wristband on a wristband reader (Miura Reader) at step 612. The wristband reader reads and encrypts the NFC wristband data and returns it to the event admin tool at step 614. The event admin tool extracts the wristband ID from the track 2 discretionary data and saves it to the database in association with the customer at step 616. The wristband is added and linked to the customer profile at step 618. The customer is then given the activated and registered wristband for use during the event at step 620.

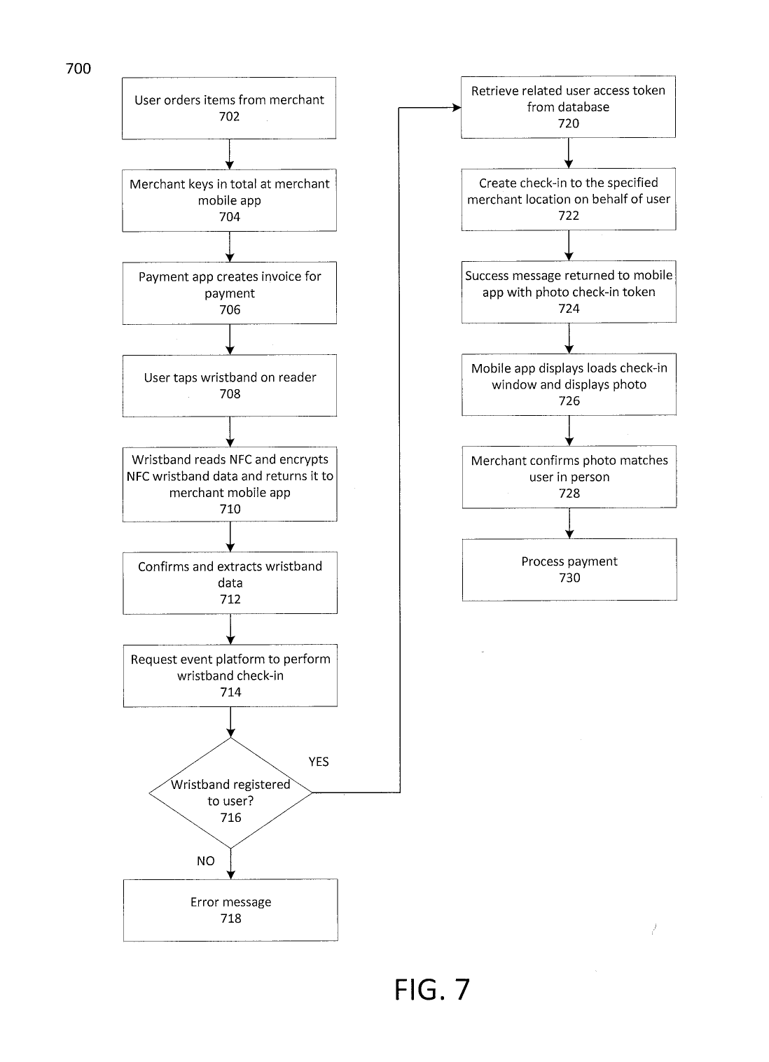

FIG. 7 is a diagram illustrating a transaction process 700 using a wearable device, such as at steps 405a-406 in FIG. 4. At a merchant/vendor, a customer (event attendee) may purchase items at step 702. At the merchant's device, the cashier may key in total amount for the purchase at step 704. The merchant device may generate an invoice for the purchase at step 706. The customer may tap the wristband on a merchant's device to make a payment for the purchase at step 708. The wearable device reader may initialize and display total amount of the purchase. The wearable device reader (card reader or wristband reader) may read NFC and encrypt NFC wristband data and return it to the merchant device at step 710. The merchant device (PayPal Here iPad app) checks if the masked cad data has a IIN of 980000 at step 712. If so, it confirms that the wristband is not a card and extracts the wristband ID form the track 2 discretionary data. If a non-wristband is tapped, the system may determine that a card is used and may process payment using the card.

If a wristband is tapped, the merchant device makes a request to the Event Platform 308 to perform a wristband check-in at the merchant/vendor at step 714. In particular, the request includes the wristband ID and the location ID of the merchant device. The Event Platform looks up the wristband to confirm if the wristband is registered to a customer at step 716. If not, return an error message to the merchant device at step 718. If so, get the customer's access token from the database at step 720. The payment service provider then creates check-in to the merchant's location on behalf of the customer at step 722. If the customer check-in is not successful, an error message is returned to the merchant device. If the customer check-in is successful, return a success message to the merchant device with a TabID which is a photo check-in token at step 724. The merchant device receives the TabID and loads check-in window and display photo of customer at step 726. The merchant's cashier confirms that the photo matches the wearer of the wristband at step 728. The payment is then processed at step 730. If the payment is successfully processed, the purchase transaction is completed. If the payment process fails, an error message is send to the merchant device.

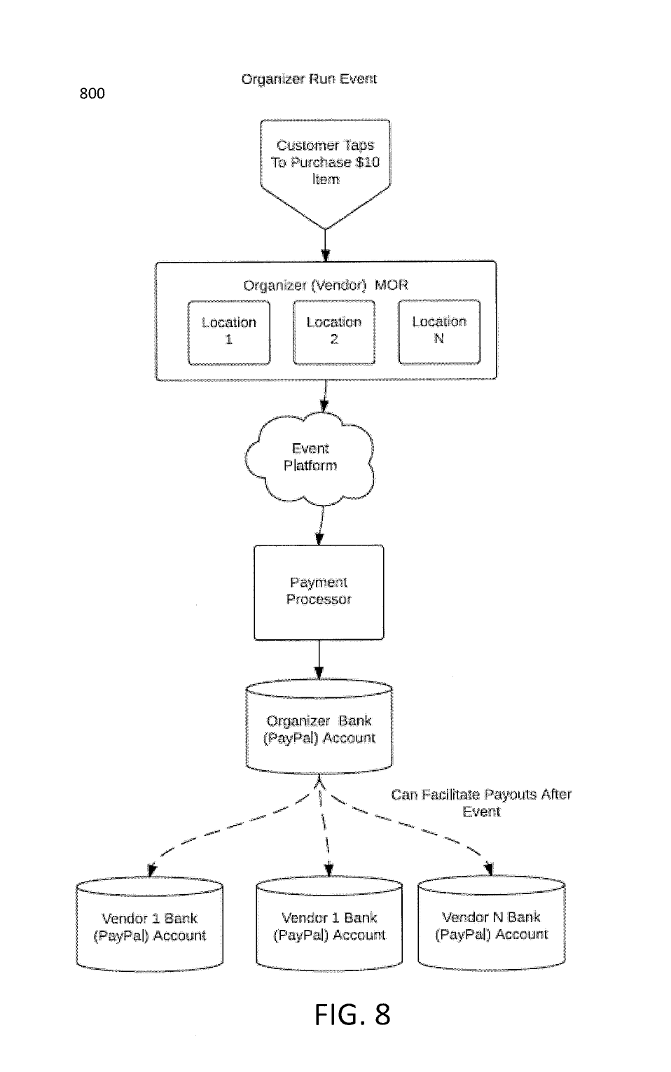

FIG. 8 is a diagram illustrating a transaction flow 800 in an organizer run event, such as in an organizer only payment model. In the organizer run event, the event organizer is the merchant of record (MOR) for all transactions in the event. The transactions are processed between the event attendees and the event organizer Merchants/vendors or locations of the transactions may be recorded. All payments are first received by the account of the event organizer and then distributed to the appropriate vendors/merchants' accounts. Fees or commissions may be taken out from the proceeds, as agreed between the event organizer and the vendors/merchants, before the proceeds are deposited into the appropriate vendors/merchants' accounts. For example, when a user makes a payment at a vendor during the event, the location or vendor ID may be recorded with the payment transaction. The payment amount is taken from the user's account and deposited into the event organizer's account. The payment is then distributed from the event organizer's account to the vendor's account based on the location of the transaction or the vendor ID associated with the transaction. The distribution may occur periodically, such as daily or twice a day.

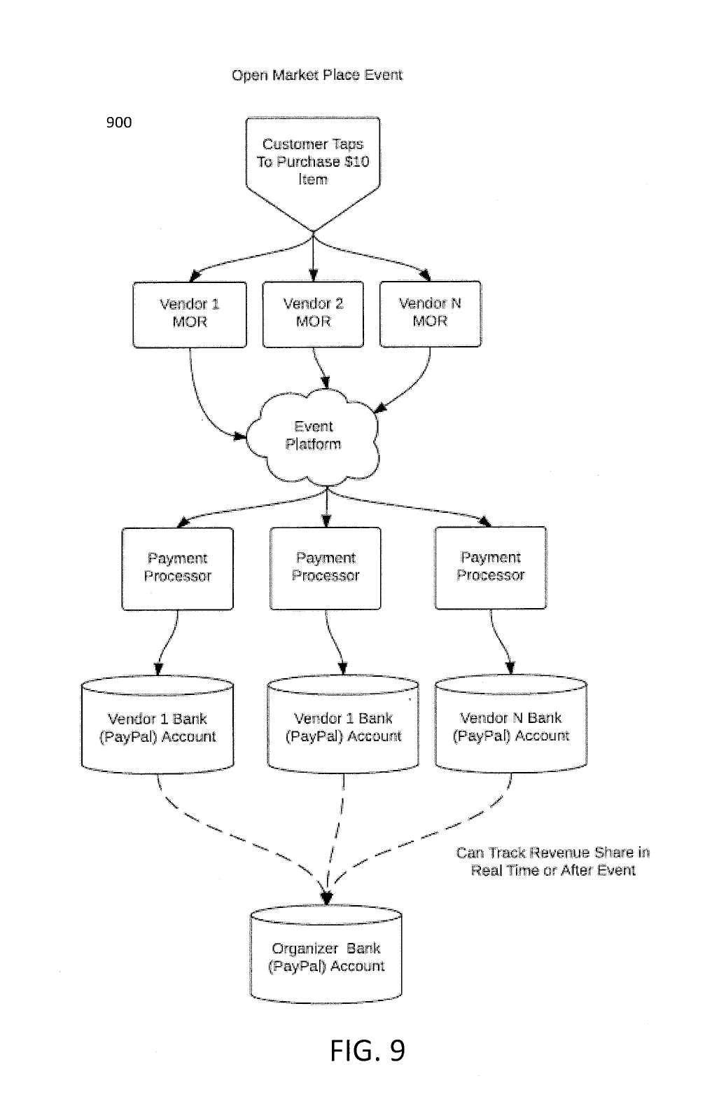

FIG. 9 is a diagram illustrating a transaction flow 900 in an open marketplace event, such as in an open marketplace payment model. In the open marketplace event, each vendor/merchant sets up its own POS system and each vendor/merchant is its own merchant of record (MOR). When customer makes purchases at merchants/vendors, the payment provider server 170 processes each payment transactions and deposits each payment into the account of appropriate vendor/merchant. The payment provider server 170 may then debit each of the vendor/merchant accounts for any fee or commissions charged by the event organizer and credit the fees or commissions to the event organizer's account.

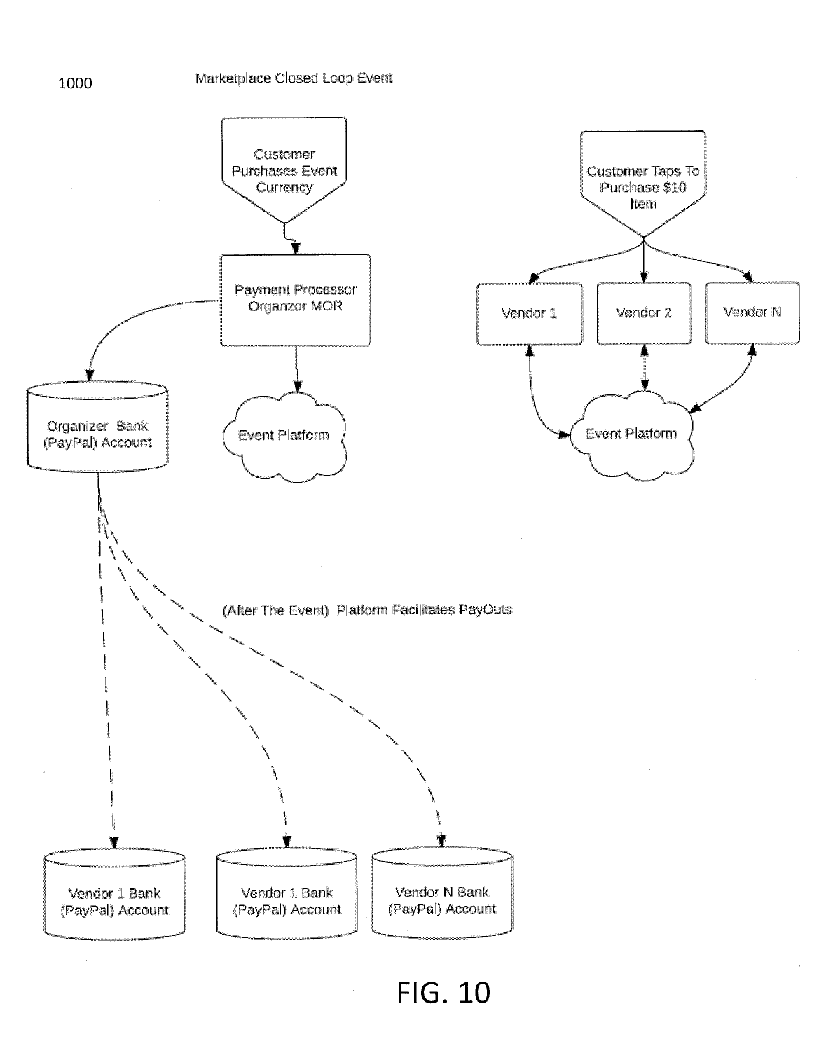

FIG. 10 is a diagram illustrating a transaction flow 1000 in a marketplace closed loop event, such as a closed loop marketplace payment model. In the closed loop marketplace event, the customers (event attendees) first purchases event currency, such as event coupons or tokens, from the event organizer. The purchased funds are deposited into the account of the event organizer. As such, the event organizer is the merchant of record. When the customers make purchases from the vendors/merchants, the purchase transactions are recorded. After the event, the payment provider server 170 performs payout from the event organizer's account to appropriate vendors/merchants' accounts, based on the transaction records.

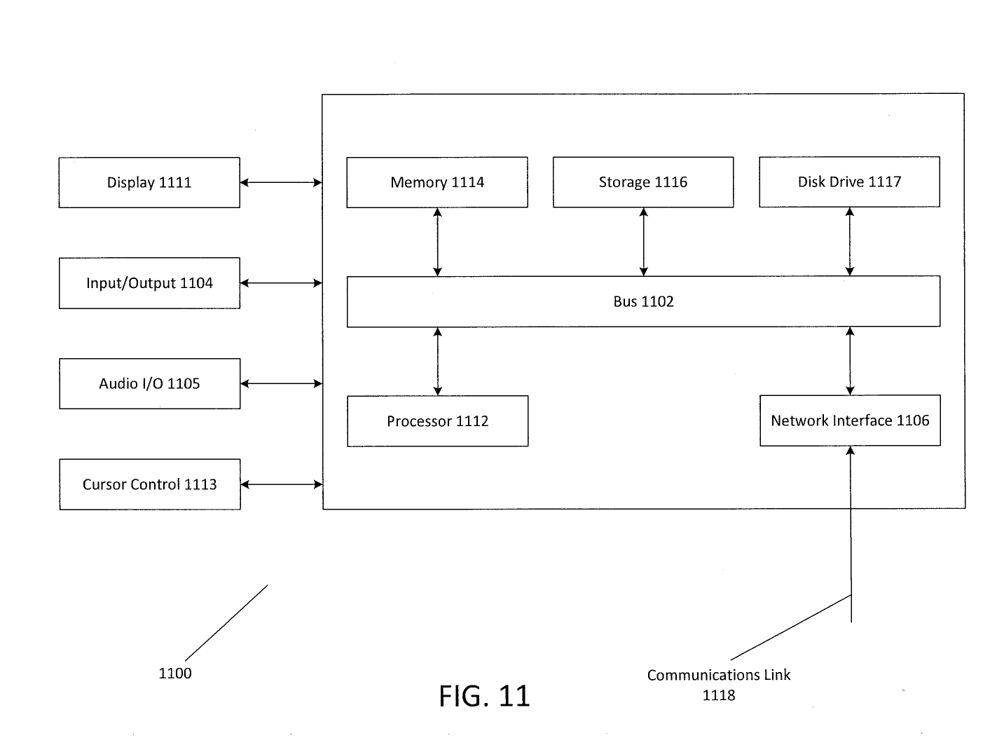

FIG. 11 is a block diagram of a computer system 1100 suitable for implementing one or more embodiments of the present disclosure. In various implementations, the user device may comprise a personal computing device (e.g., smart phone, a computing tablet, a personal computer, laptop, Bluetooth device, key FOB, badge, wearable computing device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 1100 in a manner as follows.

Computer system 1100 includes a bus 1102 or other communication mechanism for communicating information data, signals, and information between various components of computer system 1100. Components include an input/output (I/O) component 1104 that processes a user action, such as selecting keys from a keypad/keyboard, selecting one or more buttons or links, etc., and sends a corresponding signal to bus 1102. I/O component 1104 may also include an output component, such as a display 1111 and a cursor control 1113 (such as a keyboard, keypad, mouse, etc.). An optional audio input/output component 1105 may also be included to allow a user to use voice for inputting information by converting audio signals. Audio I/O component 1105 may allow the user to hear audio. A transceiver or network interface 1106 transmits and receives signals between computer system 1100 and other devices, such as another user device, a merchant device, or a payment provider server via network 160. In one embodiment, the transmission is wireless, although other transmission mediums and methods may also be suitable. A processor 1112, which can be a micro-controller, digital signal processor (DSP), or other processing component, processes these various signals, such as for display on computer system 1100 or transmission to other devices via a communication link 1118. Processor 1112 may also control transmission of information, such as cookies or IP addresses, to other devices.

Components of computer system 1100 also include a system memory component 1114 (e.g., RAM), a static storage component 1116 (e.g., ROM), and/or a disk drive 1117. Computer system 1100 performs specific operations by processor 1112 and other components by executing one or more sequences of instructions contained in system memory component 1114. Logic may be encoded in a computer readable medium, which may refer to any medium that participates in providing instructions to processor 1112 for execution. Such a medium may take many forms, including but not limited to, non-volatile media, volatile media, and transmission media. In various implementations, non-volatile media includes optical or magnetic disks, volatile media includes dynamic memory, such as system memory component 1114, and transmission media includes coaxial cables, copper wire, and fiber optics, including wires that comprise bus 1102. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 1100. In various other embodiments of the present disclosure, a plurality of computer systems 400 coupled by communication link 1118 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A wearable device comprising:
a non-transitory memory storing an unique ID of the wearable device;
a communication device configured to communicate with other devices via Near Field Communication (NFC); and
a controller configured to control the communication device to communicate the unique ID of the wearable device to a merchant device of a merchant in response to a payment request for a purchase made by a user of the wearable device.

2. The wearable device of claim 1, wherein the unique ID of the wearable device is stored as Track 2 discretionary data.

3. The wearable device of claim 1, wherein the unique ID of the wearable device is associated with a payment account of the user at a payment service provider during an activation process when the user receives the wearable device at an event.

4. The wearable device of claim 1, wherein the unique ID is communicated in response to the user tapping the wearable device on a wearable device reader of the merchant.

5. The wearable device of claim 1, wherein the unique ID is restricted for use during an event.

6. A system comprising:
a non-transitory memory; and
one or more hardware processors coupled to the non-transitory memory and configured to read instructions from the non-transitory memory to cause the system to perform operations comprising:
receiving a payment request including an unique ID of a wearable device read by a wearable device reader at a vendor at an event;
associating the unique ID of the wearable device with an account of a user attending the event;
communicating a photo of the user to the vendor;
receiving a confirmation from the vendor indicating that the photo matches the user; and
processing the payment request in response to receiving the confirmation.

7. The system of claim 6, further comprising extracting the unique ID of the wearable device from track two discretionary data stored with the wearable device.

8. The system of claim 6, further comprising:
receiving registration information of the user before the user arrives at the event; and
activating the wearable device by associating the unique ID of the wearable device with the account of the user when the user arrives at the event.

9. The system of claim 6, further comprising:
checking the user in at a location of the vendor at the event; and
communicating a message indicating that the user has checked in at the location of the vendor.

10. The system of claim 6, wherein processing the payment request comprises:
transferring an amount of the payment request from the account of the user to an account of an event organizer; and
distributing the amount of the payment request from the account of the event organizer to an account of the vendor based on a transaction location or a vendor ID associated with the payment request.

11. The system of claim 6, wherein processing the payment request comprises:
transferring an amount of the payment request from the account of the user to an account of the vendor; and
transferring a fee associated with the event from the account of the vendor to an account of an event organizer.

12. The system of claim 6, wherein processing the payment request comprises:
transferring an amount of the payment request from an account of an event organizer to an account of the vendor; and
deducting the amount of payment request from an event currency purchased by the user from the event organizer.

13. A method comprising:
receiving a payment request including an unique ID of a wearable device read by a wearable device reader at a vendor at an event;
associating the unique ID of the wearable device with an account of a user attending the event;
communicating a photo of the user to the vendor;
receiving a confirmation from the vendor indicating that the photo matches the user; and
processing the payment request in response to receiving the confirmation.

14. The method of claim 13, further comprising extracting the unique ID of the wearable device from track two discretionary data stored with the wearable device.

15. The method of claim 13, further comprising:
receiving registration information of the user before the user arrives at the event; and
activating the wearable device by associating the unique ID of the wearable device with the account of the user when the user arrives at the event.

16. The method of claim 13, further comprising:
checking the user in at a location of the vendor at the event; and
communicating a message indicating that the user has checked in at the location of the vendor.

17. The method of claim 13, wherein processing the payment request comprises:
transferring an amount of the payment request from the account of the user to an account of an event organizer; and
distributing the amount of the payment request from the account of the event organizer to an account of the vendor based on a transaction location or a vendor ID associated with the payment request.

18. The method of claim 13, wherein processing the payment request comprises:
transferring an amount of the payment request from the account of the user to an account of the vendor; and
transferring a fee associated with the event from the account of the vendor to an account of an event organizer.

19. The method of claim 13, wherein processing the payment request comprises:
transferring an amount of the payment request from an account of an event organizer to an account of the vendor; and
deducting the amount of payment request from an event currency purchased by the user from the event organizer.

20. The method of claim 13, wherein the unique ID of the wearable device is communicated to the wearable device reader via Near Field Communication (NFC).
